(19) United States
(12) Patent Application Publication
(10) Pub. No.: US 2003/0129283 A1
(43) Pub. Date: Jul. 10, 2003

(54) Food and beverage metallic containers and closures having light sensitive UV coating

(75) Inventor: Jose Luis Martinez Carballido, Monterrey (MX)

Correspondence Address: OBLON, SPIVAK, MCCLELLAND, MAIER & NEUSTADT, P.C., 1940 DUKE STREET, ALEXANDRIA, VA, 22314, US

(73) Assignee: Fabricas Monterrey, S.A. de C.V., Mexico (MX)

(21) Appl. No.: 10/036,438

(22) Filed: Jan. 7, 2002

(51) Int. Cl. A23B 4/00

(52) U.S. Cl. 426/107

(57) ABSTRACT

The present invention provides a metallic food or beverage container or closure, which includes a fluorescent coating thereon,

wherein the fluorescent coating is invisible in the absence of exposure to UV radiation and becomes visible upon exposure to UV radiation. Other embodiments of the present invention provide methods of making and using the above-mentioned container or closure.

### BACKGROUND OF THE INVENTION

1. Field of the Invention

The present invention relates to food and beverage metallic containers and closures. The coating on the metal sheet includes a fluorescent pigment or colorant formulation that produces visual/optical effects when stimulated by ultraviolet radiation allowing easily identification.

2. Discussion of the Background

Common closures for food and beverage containers may be easily copied. Food and beverage manufacturers who take great pains to ensure that their products have the highest quality possible are often thwarted by those who sell low quality substitute products under copied containers and/or closures. Both the consumer and the true manufacturer are harmed by the low quality substitute copied products. It would thus be desirable to provide a secure and reliable means of packaging a product, which could not be easily copied or contaminated and in which the consumer, distributor and/or retailer could be confident in that it contains the genuine product.

Fluorescent colorant pigments have been commonly used to print materials as textile, paper, etc.

### SUMMARY OF THE INVENTION

One object of the present invention is to provide a food and beverage container and/or closure that prevents easy copying.

Another object of the present invention is to provide a food and beverage container and/or closure that can be easily identified and/or traced.

Another object of the present invention is to provide a food and beverage container and/or closure with which one can identify and verify a genuine product contained therein and distinguish it from copies.

Another object of the present invention is to provide a food and beverage container and/or closure which helps prevent the substitution or contamination of the product contained therein or helps detect when the product has been substituted or contaminated.

These and other objects have been achieved by the present invention, the first embodiment of which provides a metallic food or beverage container or closure, which includes a fluorescent coating thereon,

wherein the fluorescent coating is invisible in the absence of exposure to UV radiation and becomes visible upon exposure to UV radiation.

Another embodiment of the present invention provides a method for preparing the above-mentioned container or closure, which includes:

contacting the container or closure with the coating.

Another embodiment of the present invention provides a method, which includes:

irradiating the above-mentioned container or closure with UV light.

Another embodiment of the present invention provides a consumer product, which includes:

the above-mentioned container or closure; and

a food or beverage sealed therein.

### DESCRIPTION OF THE PREFERRED EMBODIMENTS

Various other objects, features and attendant advantages of the present invention will be more fully appreciated as the same becomes better understood from the following detailed description of the preferred embodiments of the invention.

The present invention is particularly suitable for any food and/or beverage metallic containers and/or closures. With the present invention, it is possible to identify and/or trace food and beverage containers and closures using fluorescent coatings that are not visible under normal light but become visible under ultraviolet (UV) light. The present invention provides a special closure printed with fluorescent inks which allows one to identify a genuine product and distinguish from copies. The present invention is particularly suitable for applications in which it is important to guarantee a secure and reliable product, to avoid product contamination, and/or copying. The present invention is also suitable for novelty and/or promotional purposes.

Preferably, the fluorescent coating is used for detection purposes in applications relating to food and/or beverage metallic containers and/or closures.

Preferably, the fluorescent coatings are not visible under normal light (including sunlight) but become visible under excitation causing fluorescence, particularly with blacklight fluorescent lamp. The fluorescent coating according to the present invention preferably becomes visible only when exposed to blacklight fluorescent lamp, which preferably radiates near ultraviolet range (300-400 nm) light.

Preferably, the food and beverages metallic container and closures have a fluorescent coating which produces an intense fluorescence under a blacklight fluorescent lamp.

The food and beverage metallic containers and closures are decorated by means of printing inks and a clear coating in order to protect the image and prevent corrosion.

Preferred printing inks include one or more alkyd resins.

Preferred clear coatings include polyester, epoxy, epoxy ester and acrylic resins.

The fluorescent coating can optionally include one or more additives such as binders, antistatic agents, non-fluorescent pigments, inks or dyes, and the like. These additives are known and may be chosen as appropriate.

The printing method is not particularly limited, and any method known for printing metals may be used. Preferably a lithographic process is used wherein inks and varnish are applied with rollers on the flat metal sheet.

The food and beverages metallic containers and closures of the present invention are printed with a fluorescent coating, which becomes visible under ultraviolet radiation. In this context, the term invisible preferably means that which cannot be seen under normal light conditions (including sunlight), but which can be seen with exposure to UV radiation. More preferably, the term invisible means transparent or colorless, and visible means opaque or colored.

Preferred ultraviolet fluorescent pigments suitable for the present invention include 2,2-′(2,5-thiophenediyl)bis(5-tert-butylbenzoxazole) having the following structure:

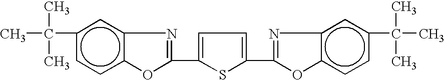

2,2′-(2,5-thiophenediyl)bis(5-nitro-benzoxazole) or 2,2′-(2,5-thiophenediyl)bis(5-tertpentyl-benzoxazole) are also preferred pigments. These and the above pigment may be used alone or in combination.

The coated closure is then exposed to black light fluorescent lamp about 300-400 nanometers. Light from this source is absorbed by the pigment and converted to energy in the visible portion of the spectrum where it appears as fluorescence.

An especially preferred UV source is a fluorescent lamp produced by Keo San Enterprise Co.

The closure may optionally include a liner or detachable liner on the container side of the closure. A transfer ink may be printed on the side of the closure that is in contact with the detachable liner and transfers to the detachable liner from the closure because of a higher affinity to the liner than to the closure. An especially preferred embodiment of the present invention thus includes a metal closure having a fluorescent pigment layer on the upper surface thereof and, on a lower surface thereof (and opposite to the upper surface), an epoxy varnish layer, a printed layer that includes a transfer ink made from a polyester resin in contact with the varnish layer, and a polyvinyl chloride resin-containing detachable layer in contact with the printed layer. An especially preferable closure having a detachable liner is described in a concurrently filed, copending U.S. application by the present inventor, identified as attorney docket number 217016US and entitled “Cap Closure and Detachable Liner”, the entire contents of which being hereby incorporated by reference.

Having now fully described this invention, it will be apparent to one of ordinary skill in the art that many changes and modifications can be made thereto without departing from the spirit or scope of the invention as set forth herein.

1. A metallic food or beverage container or closure, comprising a fluorescent coating thereon,
wherein said fluorescent coating is invisible in the absence of exposure to UV radiation and becomes visible upon exposure to UV radiation.

2. The container or closure of claim 1, wherein said coating is transparent or colorless in the absence of exposure to UV radiation.

3. The container or closure of claim 1, wherein said fluorescent coating comprises at least one fluorescent pigment.

4. The container or closure of claim 1, wherein said fluorescent coating further comprises a binder.

5. The container or closure of claim 1, which is in the form of a container selected from the group consisting of a can or a square container.

6. The container or closure of claim 1, which is in the form of a closure selected from the group consisting of a crown closure and a screw closure.

7. The container or closure of claim 1, wherein said fluorescent coating comprises a pigment having the following formula:

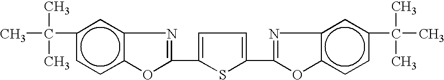

8. The container or closure of claim 1, wherein said fluorescent coating comprises at least one fluorescent pigment selected from the group consisting of 2,2-′(2,5-thiophenediyl)bis(5-tert-butylbenzoxazole), 2,2′-(2,5-thiophenediyl)bis(5-nitro-benzoxazole), 2,2′-(2,5-thiophenediyl)bis(5-tertpentyl-benzoxazole), and a mixture thereof.

9. A method for preparing the container or closure of claim 1, comprising:
contacting said container or closure with said coating.

10. A method, comprising:
irradiating the container or closure of claim 1 with UV light.

11. A consumer product, comprising:
the container or closure of claim 1; and
a food or beverage sealed therein.
